(19) United States
(12) Patent Application Publication
(10) Pub. No.: US 2025/0055301 A1
(43) Pub. Date: Feb. 13, 2025

(54) CONTROLLERS, CHARGING DEVICES, AND METHODS FOR CONTROLLING A CHARGING CIRCUIT

(71) Applicant: Murata Manufacturing Co., Ltd., Kyoto (JP)

(72) Inventors: David GIULIANO, Bedford, NH (US); Ibrahim SEZAN, San Diego, CA (US); Andrew BORJA, San Jose, CA (US)

(21) Appl. No.: 18/585,075

(22) Filed: Feb. 23, 2024

Related U.S. Application Data
(63) Continuation-in-part of application No. 18/446,462, filed on Aug. 8, 2023.

(51) Int. Cl. H02J 7/00

(52) U.S. Cl. CPC H02J 7/007194; H02J 7/00034; H02J 7/0048; H02J 7/005; H02J 2207/20

(57) ABSTRACT

A method for controlling a charging circuit includes: receiving battery information of a battery from an electrical device to be charged; receiving one or more characteristic parameters from the electrical device; selecting, from multiple charging mode candidates, a target charging mode according to the battery information and the one or more characteristic parameters; and controlling a controller to adjust one or more operating parameters of the charging circuit based on the selected target charging mode for charging the electrical device.

### CROSS-REFERENCE TO RELATED APPLICATIONS

The present application is a continuation-in-part and claims priority to and the benefits of U.S. patent application Ser. No. 18/446,462, filed on Aug. 8, 2023, the entire content of which is incorporated herein by reference.

### TECHNICAL FIELD

The present disclosure generally relates to power electronic devices. More particularly, the present disclosure relates to methods for controlling a charging circuit.

### BACKGROUND

Nowadays, many electronic products, such as mobile computing devices and/or communication products (e.g., smart phones, notebook computers, ultra-book computers, tablet devices, etc.) may support various charging schemes. For example, some electronic devices may enable a high-speed charging function using a relative high output power to rapidly charge the battery in the electronic devices to provide better user experience, or enable a maintenance charging mode using a low output power to extend the battery life and avoid the degradation of the battery. To support charging schemes for different applications or system conditions, the battery chargers need to adjust the output voltage and/or current dynamically in response to commands from the electronic products. Accordingly, it has become a critical challenge in the field to design high-efficiency power conversion circuits, improve the charging capability and the circuit design flexibility, and to meet the power requirements for different electronic products.

### SUMMARY

Embodiments of the present disclosure provide a method for controlling a charging circuit. The method includes: receiving battery information of a battery from an electrical device to be charged; receiving one or more characteristic parameters from the electrical device; selecting, from multiple charging mode candidates, a target charging mode according to the battery information and the one or more characteristic parameters; and controlling a controller to adjust one or more operating parameters of the charging circuit based on the selected target charging mode for charging the electrical device.

Embodiments of the present disclosure provide a controller for controlling a charging circuit. The controller includes a memory storing a set of instructions and one or more processors coupled to the memory and configured to execute the set of instructions to cause the controller to perform operations including: selecting, from multiple charging mode candidates, a target charging mode according to battery information of a battery and one or more characteristic parameters received from an electrical device to be charged; and adjusting one or more operating parameters of the charging circuit based on the selected target charging mode for charging the electrical device.

Embodiments of the present disclosure provide a charging device. The charging device includes a charging circuit and a controller. The charging circuit is electrically coupled to a programmable power supply circuit, the programmable power supply circuit being configured to provide a regulated DC input voltage. The charging circuit includes a first dc-dc converter electrically coupled to the programmable power supply circuit and configured to convert the regulated DC input voltage to an output voltage at an output node. The controller is configured to: receive battery information from an electrical device to be charged; receive one or more characteristic parameters; select, from multiple charging mode candidates, a target charging mode according to the battery information and the one or more characteristic parameters; and adjust one or more operating parameters of the charging circuit based on the selected target charging mode for charging an electrical device.

Additional features and advantages of the disclosed embodiments will be set forth in part in the following description, and in part will be apparent from the description, or may be learned by practice of the embodiments. The features and advantages of the disclosed embodiments may be realized and attained by the elements and combinations set forth in the claims.

### BRIEF DESCRIPTION OF THE DRAWINGS

Embodiments and various aspects of the present disclosure are illustrated in the following detailed description and the accompanying figures. It is noted that, in accordance with standard practice in the industry, various features are not drawn to scale. In fact, the dimensions of the various features may be arbitrarily increased or reduced for clarity of discussion.

FIG. 1 is a block diagram of an example charging system for an electrical device, in accordance with some embodiments of the present disclosure.

FIG. 2 is a diagram illustrating charging characteristics of multiple charging mode candidates, in accordance with some embodiments of the present disclosure.

FIG. 3 is a flowchart of a method for controlling a charging circuit, in accordance with some embodiments of the present disclosure.

FIG. 4 is a diagram of an example charging mode selector, in accordance with some embodiments of the present disclosure.

FIG. 5 is a diagram illustrating an example lookup table (LUT) containing the candidate sets of the operating parameters, in accordance with some embodiments of the present disclosure.

FIG. 6 is a diagram illustrating a performance plane for the charging modes, in accordance with some embodiments of the present disclosure.

FIG. 7 is a diagram illustrating a mapping between a training set and a corresponding resultant set of the neural network, in accordance with some embodiments of the present disclosure.

FIG. 8A is a block diagram of an example charging circuit, in accordance with some embodiments of the present disclosure.

FIG. 8B to FIG. 8E illustrate example charging modes and corresponding power flows in the charging circuit of FIG. 8A, in accordance with some embodiments of the present disclosure.

FIG. 9 to FIG. 13 are block diagrams of example charging circuits, in accordance with some embodiments of the present disclosure.

FIG. 14A is a block diagram of another example charging circuit, in accordance with some embodiments of the present disclosure.

FIG. 14B and FIG. 14C illustrate example power flows in the charging circuit of FIG. 14A, in accordance with some embodiments of the present disclosure.

FIG. 15 is a block diagram of another example charging circuit, in accordance with some embodiments of the present disclosure.

### DETAILED DESCRIPTION

The following disclosure provides many exemplary embodiments, or examples, for implementing different features of the provided subject matter. Specific simplified examples of components and arrangements are described below to explain the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In this document, the term “coupled” may also be termed as “electrically coupled”, and the term “connected” may be termed as “electrically connected”. “Coupled” and “connected” may also be used to indicate that two or more elements cooperate or interact with each other.

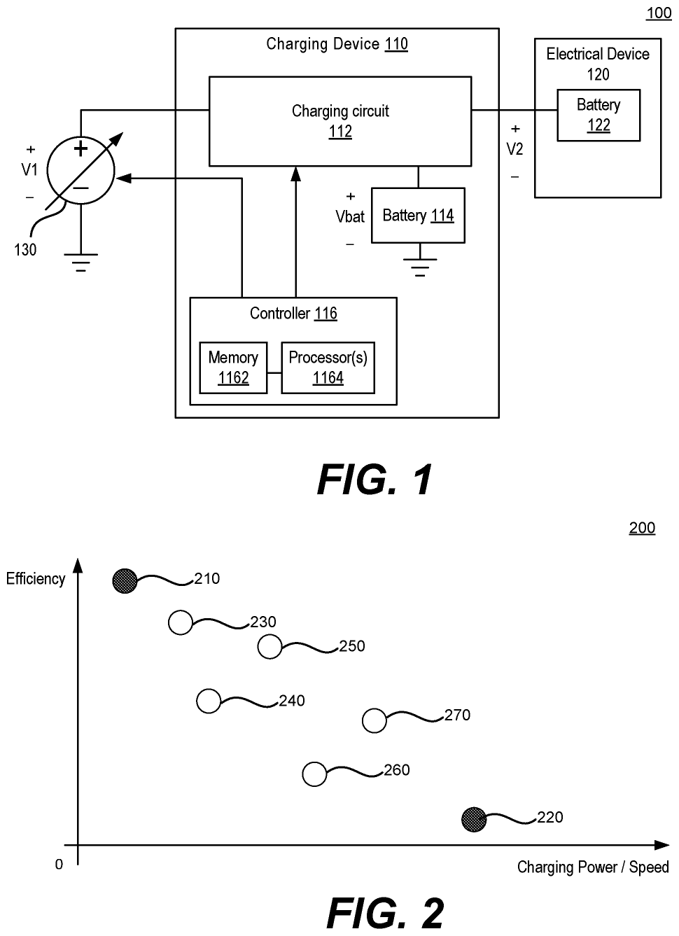

FIG. 1 is a block diagram of an example charging system 100 for an electrical device, in accordance with some embodiments of the present disclosure. The charging system 100 of FIG. 1 includes a charging device 110 having a charging circuit 112, a battery 114 electrically coupled to the charging circuit 112, and a controller 116 for controlling the charging circuit 112. The charging circuit 112 is electrically coupled to an electrical device 120 having an internal battery 122, and configured to charge the electrical device 120 by the control of the controller 116. The controller 116 includes a memory 1162 and one or more processors 1164 coupled to the memory 1162. The charging system 100 also includes a programmable power supply circuit 130 as the power source of the charging device 110.

Specifically, the charging circuit 112 in FIG. 1 is electrically coupled to the programmable power supply circuit 130. The programmable power supply circuit 130 can be an Adjustable Voltage Source (AVS) and configured to provide a regulated DC input voltage V1. The voltage level of the regulated DC input voltage V1 can be dynamically adjusted by the programmable power supply circuit 130, in response to corresponding commands from the controller 116. In some embodiments, the regulated DC input voltage V1 may be a supply voltage from an AC-DC adaptor. The dc-dc converter(s) in the charging circuit 112 may be electrically coupled to the programmable power supply circuit 130 and configured to convert the regulated DC input voltage V1 to an output voltage V2 at an output node of the charging device 110. In some embodiments, the battery 114 within the charging device 110 is configured to be charged or discharged, directly or indirectly by the power from the charging circuit 112 or the programmable power supply circuit 130. The output node of the charging device 110 can be electrically coupled, directly or via a separate charging cable, to one or more electrical devices 120 having the internal battery 122 for supplying the power required by the electrical device(s) 120. Thus, the battery 122 in the electrical device 120 can be charged accordingly.

In some embodiments, the charging circuit 112 may include one or more dc-dc converters to perform the power conversion between the regulated DC input voltage V1, the output voltage V2, and/or the battery voltage Vbat of the battery 114 within the charging device 110. As used herein, a power converter may refer to an apparatus containing power and electronic components of a power converting circuit. For example, the charging circuit 112 may include a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1 in FIG. 1) to an output voltage (e.g., the output voltage V2 in FIG. 1). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

As shown in the embodiments of FIG. 1, when the electrical device 120 is connected to the charging device 110, the controller 116 can control the charging circuit 112 and/or the programmable power supply circuit 130 accordingly to operate in a target charging mode to charge the battery 122 of the electrical device 120, and dynamically switch between charging modes in response to various conditions and desired outcomes (e.g., fast high-power charging or slower but more efficient charging with less damage to the battery). For example, the memory 1162 may store a set of instructions, and one or more processors 1164 coupled to the memory 1162 may be configured to execute the set of instructions stored in the memory 1162 to cause the controller 116 to perform operations of a method for controlling the charging circuit 112 and/or the programmable power supply circuit 130.

In some embodiments, the target charging mode can be selected from multiple charging mode candidates. FIG. 2 is a diagram 200 illustrating charging characteristics of multiple charging mode candidates 210-270, in accordance with some embodiments of the present disclosure. As shown in FIG. 2, the charging mode candidates 210-270 may provide different charging power and charging efficiency. The battery charging optimization involves various trade-offs between several factors, such as charging time (e.g., speed or time it takes to charge the battery fully or to a certain percentage), power efficiency, battery temperature, etc. Generally speaking, as shown in the diagram 200 of FIG. 2, a charging mode candidate 210 with a slower charging speed (or a lower charging voltage) usually consumes less power and thus achieves higher power efficiency with the reduced power consumption, which also extends the long-term battery life. More specifically, slow charging generally provides higher energy efficiency when the battery is near empty, and as the battery reaches its full capacity, the energy consumption may become less efficient, regardless of the charging method used. On the other hand, a charging mode candidate 220, which may be a fast-charging mode using a higher voltage (or power), enables the battery to charge faster and reduces the total charging time, but with lower power efficiency and possibly with a negative impact on long-term battery life/health. In view of the above, an optimized charging mode should be determined based on multiple factors, including the device type, battery capacity, current state of battery health, charging mode, personal usage patterns, etc. It is understood that the factors mentioned above are merely examples and not meant to limit the present disclosure. Charging mode candidates 230, 240, 250, 260, 270 represent a number of different charging modes, which can be dynamically selected and realized.

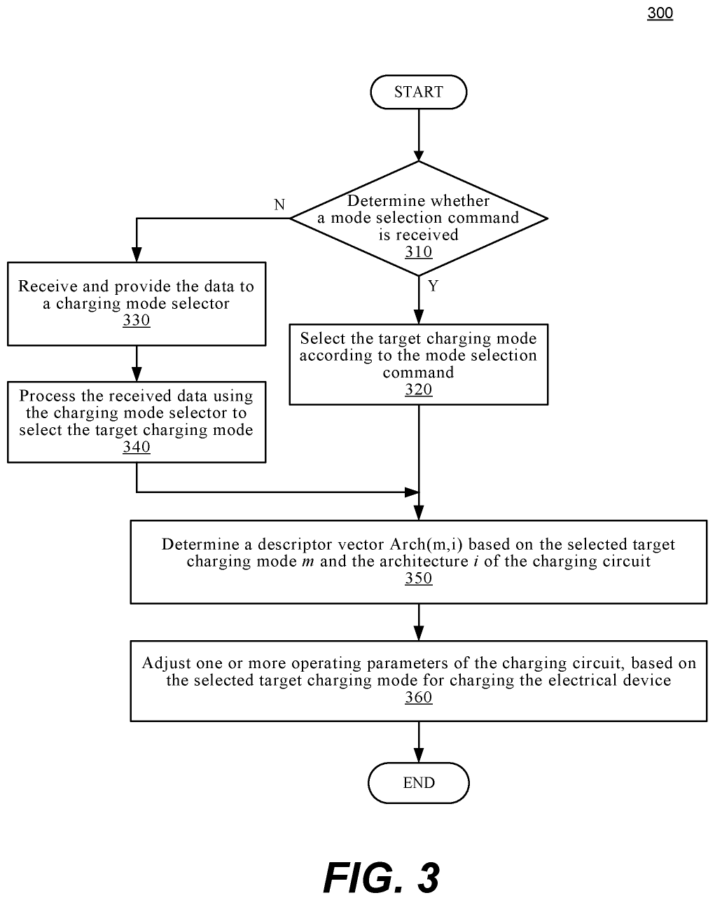

FIG. 3 is a flowchart of a method 300 for controlling a charging circuit, in accordance with some embodiments of the present disclosure. It is understood that additional operations may be performed before, during, and/or after the method 300 depicted in FIG. 3, and that some other processes may only be briefly described herein. The method 300 can be performed by a controller, e.g., the controller 116 illustrated in the embodiments of FIG. 1 above, but the present disclosure is not limited thereto.

As shown in FIG. 3, the method 300 includes steps 310-360. In step 310, the controller determines whether a mode selection command from a user is received. In response to a detection of the mode selection command from the user (step 310—yes), in step 320, the controller selects, from the charging mode candidates, the target charging mode according to the mode selection command. In other words, the user may manually select a desired charging mode (e.g., a fast-charge mode) for the electrical device (e.g., electrical device 120 in FIG. 1). The corresponding mode selection command can be transmitted from the electrical device to the controller using various wired or wireless communication protocols. Based on the received mode selection command, the controller can control the charging process according to the user's preference. When the user selects another charging mode, the controller can adjust the charging operation dynamically in response to the updated mode selection command. Thus, the target charging mode can be changed during a single charging cycle of the battery in response to a manual selection.

In response to a determination that the mode selection command is not received from the user (step 310—no), the controller may achieve an auto-adaptive charging by steps 330 and 340 to determine the target charging mode. In step 330, the controller receives data from the electrical device to be charged, and provides the received data to a charging mode selector.

Specifically, the controller may receive battery information of the battery 122 from the electrical device 120 to be charged. For example, the battery information of the battery 122 from the electrical device 120 to be charged may include a battery state of charge (SOC), a battery state of health (SOH), a temperature of the battery 122, or any combination thereof.

In addition, the controller may also receive one or more characteristic parameters from the electrical device 120. The characteristic parameters may include various data associated with the electrical device 120. For example, the characteristic parameters may include a device type (e.g., mobile devices, home appliances, electric vehicles, etc.), a use pattern of a user of the electrical device, location information, position information, time information, movement information, device temperature information, ambient temperature information (internal or external to the device), real-time power consumption information, real-time carbon emission information, historical power consumption information, or any combination thereof.

In some embodiments, the use pattern may be dependent on time of day or day of week, the user's location, etc. For example, a fast-charging mode may be selected for charging a user's mobile phone during working hours on a weekday or when the user commutes between the office and home, while a power-efficient mode may be selected during midnight hours or when the mobile phone is located at home, where the charging speed is likely not the most important factor. In various embodiments, the location information, the position information, the time information, and the movement information of the electrical device 120 may be collected from corresponding internal sensors (e.g., Global Positioning System (GPS) sensors, inertial measurement units (IMUs), etc.) within the electrical device 120, or retrieved from an external internet server.

In some embodiments, the device temperature information may be obtained from internal temperature sensors of the electrical device 120 and include one or more of an average device temperature of the electrical device 120, a maximum device temperature of the electrical device 120, or a device skin temperature of the electrical device 120, but the present disclosure is not limited thereto. In some embodiments, environmental information, such as the ambient temperature information, weather information, traffic information, may be obtained from external sensors or servers. It is noted that various characteristic parameters mentioned above are merely examples and not meant to limit the present disclosure.

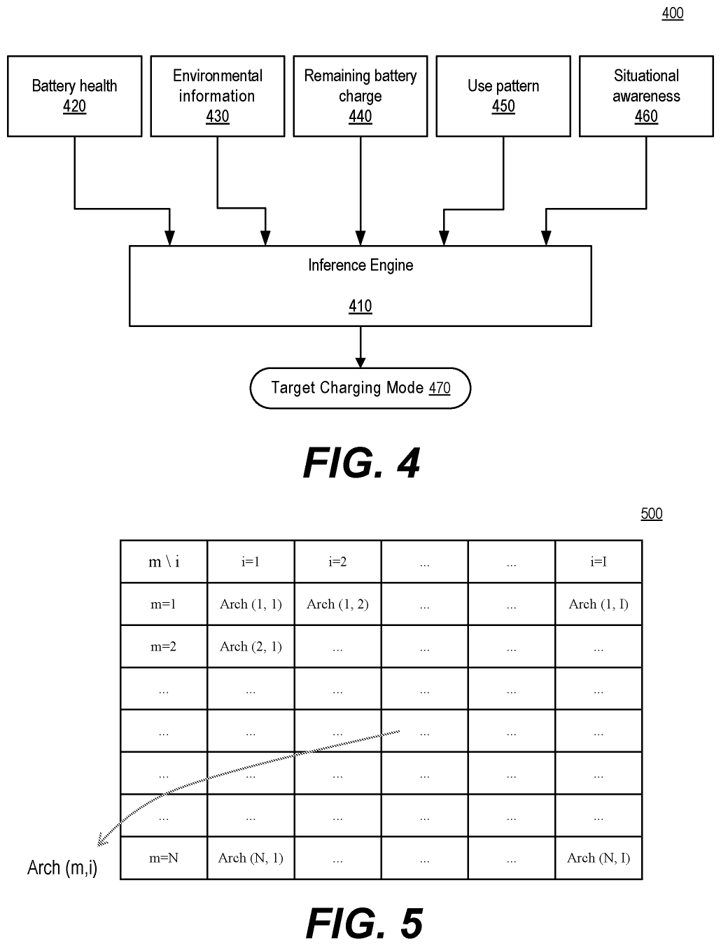

FIG. 4 is a diagram of an example charging mode selector 400, in accordance with some embodiments of the present disclosure. As shown in FIG. 4, the charging mode selector 400 may include an inference engine 410. As shown in FIG. 4, the inference engine 410 is configured to receive and process the battery information of the battery 122 (e.g., battery health information (SOH) 420 and remaining battery charge information (SOC) 440) and characteristic parameters (e.g., environmental information 430, use pattern information 450, and situational awareness information 460) from the electrical device 120, and process the received data in order to output a selected target charging mode 470 properly. For example, the environmental information 430 may include real-time ambient temperature data collected by temperature sensor(s), and the situational awareness information 460 may be real-time data collected and inferred based on inertial sensor(s). The use pattern information 450 may be inferred by a machine learning model and dependent on the location of the electrical device 120, the time of day, the day of week, etc.

The charging mode selector 400 may be configured to select the target charging mode based on one or more received data, and set multiple rules. For example, the charging mode selector 400 may select a first mode (e.g., a high-efficiency and low-power charging mode), in response to the received battery health information 420 indicating a poor battery health/longevity. In another example, if the environmental information 430 indicates that the date and time of the day coincide with a Flex Alert issued by the utility company, the charging mode selector 400 may also select the first mode. If the user has already selected a fast-charge mode for the electrical device manually, the charging mode selector 400 may also send an alert to notify the user and confirm with the user whether to switch from the fast-charge mode to a high-efficiency charging mode.

In addition, if the use pattern information 450 indicates “an overnight sleep” scenario, and the situational awareness information 460 indicates that the electrical device to be charged is not in motion, and the remaining battery charge information 440 indicates that an estimated time to reach a predetermined percentage (e.g., 80%) of full charge of the battery is within the user's expected remaining sleep hours, the charging mode selector 400 may also select the first mode (e.g., a high-efficiency and low-power charging mode), because in this situation fast-charging is unnecessary. On the other hand, if the remaining battery charge information 440 indicates that an estimated time to reach the predetermined percentage (e.g., 80%) of full charge of the battery exceeds the user's expected remaining sleep hours, the charging mode selector 400 may select different fast-charging modes to accelerate the charging. In some embodiments, the fast-charging mode can be selected according to the difference (or ratio) between the estimated time to reach the predetermined percentage and the expected remaining sleep hours.

Referring again to FIG. 3, by the operations above, after the battery information and the one or more characteristic parameters are obtained, in step 340 of the method 300, the controller may process the received data using the charging mode selector 400, and select, from the charging mode candidates, the target charging mode according to the battery information and the one or more characteristic parameters. It would be appreciated that the above example rules and settings are not meant to limit the present disclosure. In various embodiments, the charging mode selector 400 may apply various different preset rules or customized rules created by the user to determine the target charging mode.

Accordingly, with the operations of steps 310-340, the target charging mode can be selected, either manually by the user or automatically based on the received data. In addition, in response to updated commands from the user or updated characteristic parameters and/or battery information received from the electronic device to be charged, the controller may dynamically change the target charging mode during a charging cycle of the battery by repeating steps 310-340.

Then, in step 350, the controller may determine operating parameters for operating the charging circuit (e.g., charging circuit 112 in FIG. 1) according to the selected target charging mode and an architecture of the charging circuit. In some embodiments, the operating parameters may be represented by an architecture and operation descriptor vector Arch(m,i), which is a descriptor vector for power delivery (PD) and battery charging. The descriptor vector components include the values of the operating parameters for the ith architecture (1≤i≤I) for realizing the target charging mode m (1≤m≤M), where I and M denote the total number of available circuit architectures and the total number of available target modes, respectively. Specifically, in step 350, the controller may retrieve a corresponding target set of the operating parameters selected from multiple candidate sets of the operating parameters stored in a memory, e.g., through a lookup operation as described in the below, according to the target charging mode and the architecture of the charging circuit.

Then, in step 360, the controller may adjust one or more operating parameters of the charging circuit, based on the selected target charging mode for charging the electrical device 120. For example, the controller 116 may provide corresponding commands to the charging circuit 112 or the programmable power supply circuit 130, according to the descriptor vector Arch(m,i) and the corresponding target set of the operating parameters.

FIG. 5 is a diagram illustrating an example lookup table (LUT) 500 containing the candidate sets of the operating parameters stored in a memory for the method 300 in FIG. 3, in accordance with some embodiments of the present disclosure. As shown in FIG. 5, each row of the lookup table 500 represents a corresponding charging mode m and each column of the lookup table 500 represents a corresponding architecture i of the charging circuit. The corresponding cell of the m-th row, and i-th column contains the descriptor vector Arch(m,i) denoting the target set of the operating parameters for the ith circuit architecture when it is operating in charging mode m, in which i is an index of the architecture, and m is an index of the charging mode. The components of the vector Arch(m,i) are the values of the set of parameters p(m,i,j) specific to the i-th architecture operating in the m-th charging mode, in which j is an index of the operation parameter. An example vector Arch(m,i) may be expressed using the following equation:

$${Arch ( m , i ) = \\ [ p ( m , i , 1 ) ; p ( m , i , 2 , {DC}_{1} ) ; … p ( m , i , 2 , {DC}_{K} ) ) ; p ( m , i , 3 , {S}_{i} ) ; … ; p ( m , i , 3 , {S}_{P} ) ; … ; p ( m , i , J , d ) ]}^{T}$$

In the above equation, p(m,i,j) denotes the j-th operation parameter, DCₖ denotes the k-th dc-dc converter of the total K dc-dc converters in the charging circuit 112, and Sₚ denotes the p-th bypass switch of the total P switches in the charging circuit 112, where 1≤j≤J, 1≤k≤K, and 1≤p≤P. The values of J, K, and P determine the total dimension of the vector Arch(m,i).

The operation parameters p(m,i,j) are associated with one or more of a voltage level of a supply voltage (e.g., voltage V1) outputted by an adjustable voltage source (AVS) in the programmable power supply circuit 130, an architecture of the charging circuit 112, or a power flow direction of one or more power converters in the charging circuit 112.

In some embodiments, the first operation parameter p(m,i,1) may be used to describe a voltage value or a voltage range of the AVS supply voltage. For example, the parameter p(m,i,1) can be a real number and quantized to a finite set of values (e.g., a set of q values: p(m,i,1)₁, p(m,i,1)₂, . . . , p(m,i,1)_{q}) corresponding to different voltage levels (e.g., 5V, 12V, 15V, 18V, 24V, 36V, 48V, 60V, etc.). In some embodiments, one or more second operation parameters p(m,i,2,DCₖ) may be used to denote corresponding Enable/Disable flags for the k-th dc-dc converter DCₖ in the charging circuit 112. For example, the parameter p(m,i,2,DCₖ) being true (e.g., “1”) indicates that the k-th dc-dc converter DCₖ in the charging circuit 112 is enabled or active, while the parameter p(m, i, 2,DCₖ) being false (e.g., “0”) indicates that the k-th dc-dc converter DCₖ in the charging circuit 112 is disabled or inactive. In some embodiments, one or more third operation parameters p(m, i, 3,Sₚ) may be used to denote corresponding Close/Open flags for the p-th bypass switch Sₚ in the charging circuit 112. For example, the parameter p(m, i, 3,Sₚ) being true (e.g., “1”) indicates that the p-th bypass switch Sₚ in the charging circuit 112 is closed, while the parameter p(m, i, 3, Sₚ) being false (e.g., “0”) indicates that the p-th bypass switch Sₚ in the charging circuit 112 is open.

In some embodiments, a fourth operation parameter p(m, i, J, d) may be used to denote a power flow direction of the operation of the power converter(s) in the charging circuit 112. The parameter p(m, i, J, d) may be a binary value, in which the parameter p(m, i, J, d) may be a first value (e.g., “1”) indicating a forward direction of the power flow or a second value (e.g., “0”) indicating a backward direction of the power flow.

For example, a charging circuit 112 having two dc-dc converters and three bypass switches, may have a 7×1 vector Arch(m,i). If the components of the vector Arch(m,i) are [15; 1; 0; 1; 1; 0; 1]^{T}, the operation parameters indicates that when the i-th architecture operates in the m-th charging mode, the supply voltage outputted by the adjustable voltage source (AVS) is configured to 15 volts, the first dc-dc converter is configured to be active and the second dc-dc converter is configured to be inactive, the first and the second bypass switches are closed, and the third bypass switch is open, and the power converter operates in the forward direction.

Values of each candidate set represented by the descriptor vector Arch(m,i) and associated with the corresponding architecture i and the corresponding charging mode candidate m can be obtained by a processor. For example, the processor may obtain each candidate set by applying a neural network to process multiple input parameters. In various embodiments, the neural network may be implemented in different ways. For example, the neural network may be a perceptron network, a classifier network, an optimization network, or any combination thereof. In some embodiments, the neural network is configured to perform a regression between a set of the operating parameters and a corresponding charging efficiency or a corresponding charging power or time to reach a percentage of full charge of a battery, which will be discussed in more details later.

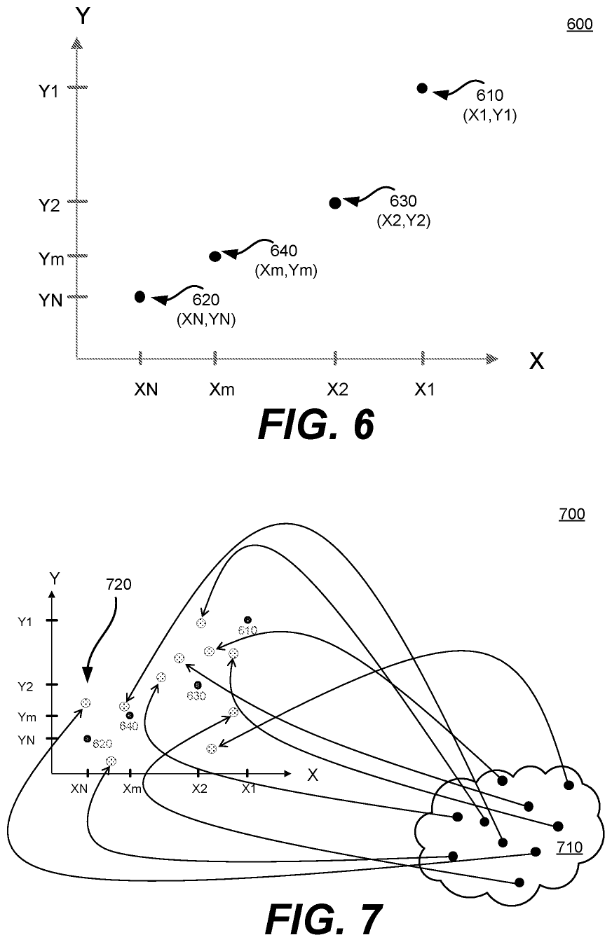

FIG. 6 is a diagram illustrating a performance plane 600 for the charging modes corresponding to the i-th architecture for the method 300 in FIG. 3, in accordance with some embodiments of the present disclosure. In the performance plane 600, the x-axis represents the charging time required to full charge, and the y-axis represents the charging efficiency. The coordinate pair (Xm, Ym) of a point defines the corresponding charging characteristics set for the m-th charging mode. In some embodiments, the charging time required to full charge (i.e., Xm) may change in time as the battery health drops. For example, in the X-Y performance plane 600, a point 610 at (X1, Y1) may represent the first charging mode providing the highest charging efficiency, a point 620 at (XN, YN) may represent the second charging mode providing the shortest charging time required. Points 630 and 640 may represent other intermediate modes providing different charging characteristics.

The parameters (e.g., components of the vector Arch(m,i)) for the i-th architecture that will result in the coordinate pair (Xm, Ym) describing a target charging mode, mode m 640, can be determined by processing an input vector through neural network. The input vector may contain multiple input parameters for the neural network. In some embodiments, the input parameters for the neural network may include the target charging mode, the architecture of the charging circuit, ambient temperature, and the battery information, etc. For example, the input vector may be expressed as: [(Xm, Ym); i; M₁ . . . . M_{w}]^{T}, in which M₁ to M_{w} are measured quantities, such as the ambient temperature and the battery information that impact the efficiency of the power delivery and the battery charging circuit. The neural network may output, in response to the received input vector, the descriptor vector Arch(m,i) as an output vector.

In some embodiments, different neural network models may be used for different temperature values. The actual measured temperature value can be quantized to a finite set of temperature values corresponding to the neural network models. In other words, the neural network model can be trained for different temperatures in the set of temperature values, and the neural network parameters may be temperature dependent. In some other embodiments, the neural network parameters may also be dependent on the battery information (e.g., the battery age), which can be quantified by the number of charging cycles performed on the battery.

FIG. 7 is a diagram illustrating a mapping 700 between a training set 710 of Arch(m,i) vectors (e.g., within a J dimensional vector space) and a corresponding resultant set 720 of values on the 2-dimensional performance plane, in accordance with some embodiments of the present disclosure. The training set 710 may be a multiple dimensional vector space (e.g., a 7-dimensional vector space) of the vectors Arch(m,i). As shown in FIG. 7, the mapping between pairs from the training set 710 and the resultant set 720 are used to determine neural network parameters. Alternatively stated, the neural network may learn from the training set 710 and the resultant set 720 to obtain neural network parameters that define the “fitting” between the training set 710 and the resultant set 720, or the regression from the resultant set 720 to the training set 710 or from the training set 710 to the resultant set 720. After the neural network is trained, then the neural network may produce a predicted vector Arch(m,i) for the given specific input coordinate pair (Xm, Ym) for a target charging mode. Note that the target modes, 610, 620, 630, 640, on the X-Y performance plane, may not coincide with the resultant set 720 as shown in FIG. 7. In some embodiments, the neural network may be a multi-layer perceptron (MLP) network and may be trained using methods such as back propagation.

As mentioned above, the neural network may be a classifier network. Specifically, a classifier network is configured to classify the input vector to a set of U classes, which are defined based on a predetermined finite set of values for the components of Arch(m,i) and their combinations. As explained above, the first operation parameter p(m,i,1) may be quantized to a finite set of q distinct values. Remaining operation parameters p(m,i,2, DCₖ) and p(m,i,3, Sₚ) and p(m, i, J, d) are binary by definition. For a specific architecture (e.g., the i-th architecture), a classifier network may be trained using a finite size training data set containing a set of specific Arch(m,i) vectors and their corresponding resultant coordinate pairs (Xm, Ym) using supervised learning. After the training, when fed by a desired target charging mode and the corresponding coordinate pair (Xm, Ym) in operation, the network will produce specific values for the Arch(m,i) vector as the result of classification. In some embodiments, the classifier network may be a perceptron network and trained using various methods, such as back propagation. For example, the neural network may be a multi-layer perceptron (MLP).

In some embodiments, the neural network may also be an optimization network, which is configured to determine its network states that maximizes/optimizes the value of a certain objective function expressed in terms of values of the neural network parameters, such as node-to-node interconnection weights and node nonlinearities (activation function), and states of the network nodes that correlate to the components of the output vector Arch(m,i).

The network objective function may be defined in terms of the efficiency of the power delivery and charging circuit for the particular i-th architecture. The network iterates (or updates) the values of the states of its nodes according to a recursion specific to a specific network (e.g., a Hopfield network). Iterations converge to states that maximize the network objective function. In other words, the network objective function iteratively reaches its local or global minimum. The states (i.e., the output vector) are then used as the architecture parameters when the maximum efficiency mode (e.g., the first charging mode at the point 610 in FIG. 6) is desired. In some embodiments, the network can be a Hopfield network with its specific objective function (or “energy function”) defined in a way that relates to the circuit efficiency. States of network nodes correspond to components of the output vector Arch(m,i). For example, the node-to-node interconnection weights can be determined by the training based on back propagation.

Thus, by training the neural network and using the trained neural network to obtain components of each vector Arch(m,i) associated with the corresponding architecture and charging mode, the controller may adjust the charging efficiency or the charging power or time to reach a percentage of full charge of the battery 122 by adjusting the corresponding operating parameter(s) in step 360 of the method 300.

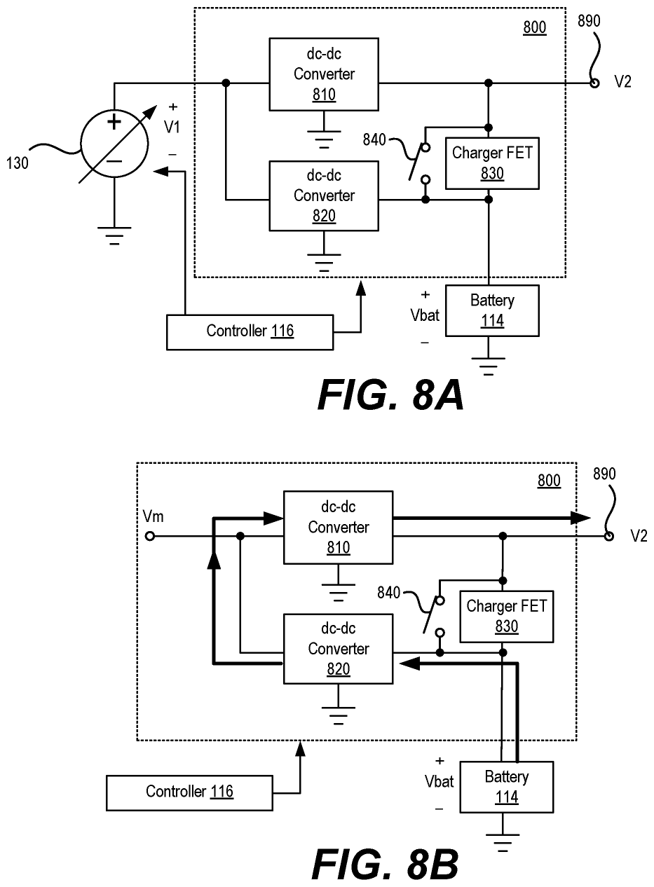

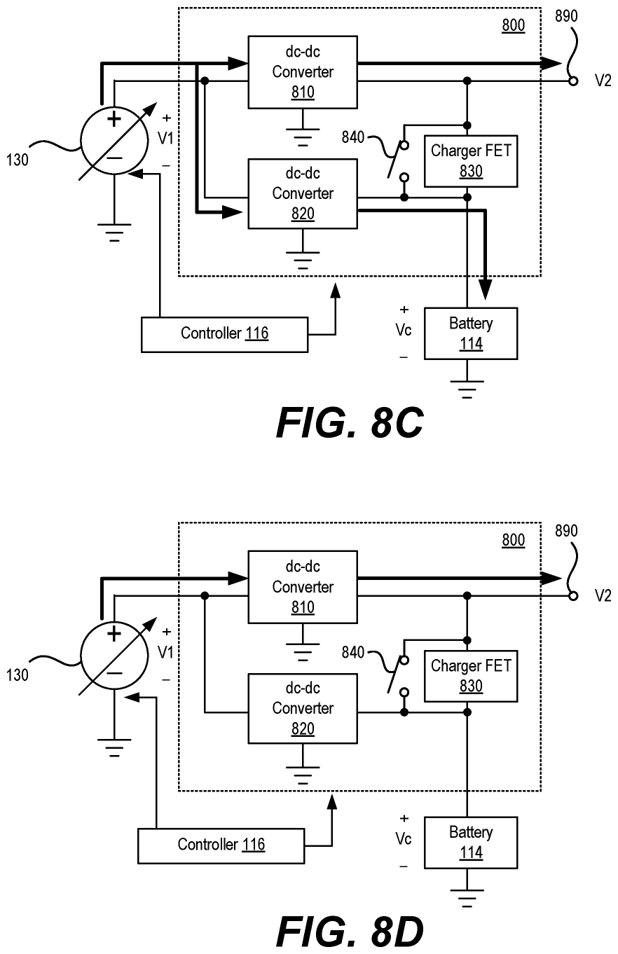

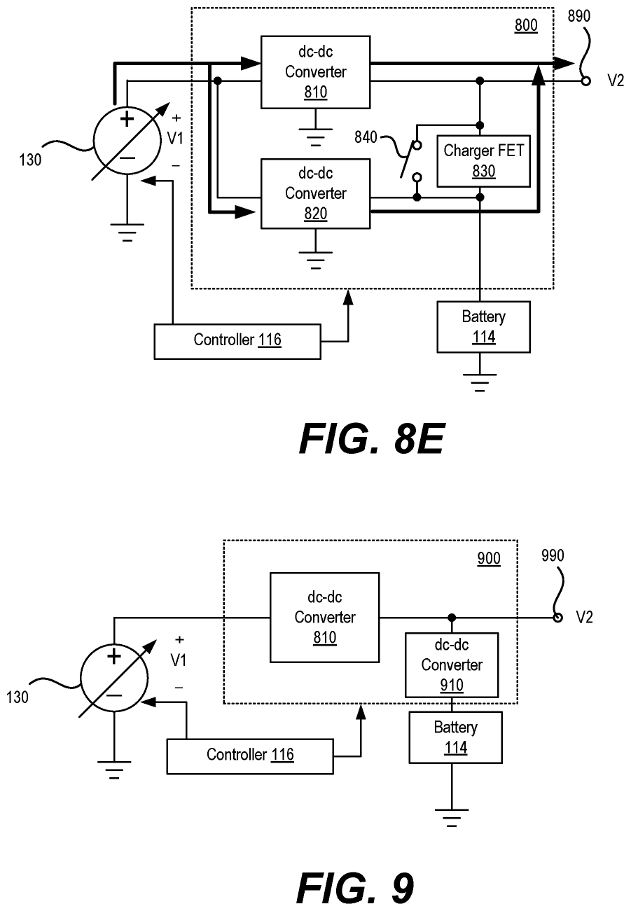

FIG. 8A is a block diagram of an example charging circuit 800, in accordance with some embodiments of the present disclosure. FIG. 8B to FIG. 8E illustrate example charging modes and corresponding power flows in the charging circuit of FIG. 8A, in accordance with some embodiments of the present disclosure. In the architecture shown in FIG. 8A to FIG. 8E, the charging circuit 800 includes dc-dc converters 810, 820, a charger transistor 830 and a switch device 840 electrically coupled in parallel to the charger transistor 830. The battery 114 is electrically coupled to the de-de converter 820. Specifically, the charging circuit 800 is electrically coupled to the programmable power supply circuit 130, which can be an Adjustable Voltage Source (AVS) and configured to provide a regulated DC input voltage V1. The voltage level of the regulated DC input voltage V1 can be dynamically adjusted by the programmable power supply circuit 130, in response to corresponding commands from the controller 116, which has been discussed in the embodiments of FIG. 1 above and thus details are not repeated herein for the sake of brevity.

In some embodiments, the dc-dc converter 810 may be a buck converter, a boost converter, or a charge pump converter, etc., but the present disclosure is not limited thereto. As used in this disclosure, the term “charge pump” refers to a switched-capacitor network configured to convert an input voltage (e.g., the regulated DC input voltage V1) to an output voltage (e.g., the output voltage V2). Examples of such charge pumps include cascade multiplier, Dickson, ladder, series-parallel, Fibonacci, and Doubler switched-capacitor networks, all of which may be configured as a multi-phase or a single-phase network. In addition, in the context of the present disclosure, power converting circuits that convert a higher input voltage power source to a lower output voltage level are commonly known as step-down or buck converters, because the converter is “bucking” the input voltage. Power converting circuits that convert a lower input voltage power source to a higher output voltage level are commonly known as step-up or boost converters, because the converter is “boosting” the input voltage. In addition, some power converters, commonly known as “buck-boost converters,” may be configured to convert the input voltage power source to the output voltage with a wide range, in which the output voltage may be either higher than or lower than the input voltage. In various embodiments, a power converter may be bidirectional, being either a step-up or a step-down converter depending on how a power source is connected to the converter.

As shown in FIG. 8A, the dc-dc converter 810 is electrically coupled to the programmable power supply circuit 130 and configured to convert the regulated DC input voltage V1 to the output voltage V2 at the output node 890 of the charging circuit 800. The battery 114 is configured to be charged or discharged, directly or indirectly via the output node 890. The dc-dc converter 820 is electrically coupled in series between the programmable power supply circuit 130 and the battery 114. The charger transistor 830 is electrically coupled between the dc-dc converter 810 and the dc-dc converter 820. In some embodiments, the dc-dc converter 810 and the dc-dc converter 820 may be configured to operate simultaneously.

In some embodiments, in step 360, the controller may selectively control a voltage level of the supply voltage (e.g., regulated DC input voltage V1) outputted by the programmable power supply circuit 130, based on the selected target charging mode. Accordingly, the output voltage V2 at the output node 890 is controlled at a desired level corresponding to the target charging mode. For example, in the first charging mode (e.g., point 610 in FIG. 6) providing a high charging efficiency using a low power output, the voltage V1 can be lowered such that the dc-dc converter 810 is highly efficient with a small transformation ratio. The first charging mode may offer about 5-10% efficiency improvement, and reduction in net carbon emissions, which is suitable for use cases where the charging time is a less important factor, such as charging at bedtime. In the second charging mode (e.g., point 620 in FIG. 6) providing a short charging time required using a high-power output, the voltage V1 can be increased, with the dc-dc converter 810 operating with a relatively large transformation ratio. The second charging mode may offer faster charging and allow the user to use the device with less waiting time, which is suitable for time sensitive use cases, such as gaming, phone charging before work, etc. In other intermediate charging modes (e.g., points 630, 640 in FIG. 6), the voltage V1 can be dynamically increased or decreased, based on detected conditions and/or user selection.

In some embodiments, in step 360, the controller may selectively enable or disable one or more power converters in the charging circuit based on the selected target charging mode. For example, in some charging modes, the dc-dc converter 820 may be disabled when a single dc-dc converter 810 is sufficient to perform the power conversion in the target charging mode.

In some embodiments, in step 360, the controller may selectively control a power flow direction of one or more dc-dc converters 810 and 820, based on the selected target charging mode. For example, in response to a first charging mode being selected, the controller may control a target power converter to receive an input power from a first end and provide an output power through a second end. In response to a second charging mode being selected, the controller may control the target power converter to receive the input power from the second end and provide the output power through the first end. In response to a third charging mode being selected, the controller may disable the target power converter to stop power from flowing through the target power converter.

For example, FIG. 8B illustrates an example charging mode and the power flow during a discharging phase of the battery 114 in the charging circuit 800 of FIG. 8A, in accordance with some embodiments of the present disclosure. As shown in FIG. 8B, in the discharging phase of the battery 114, the dc-dc converter 820 may be configured to convert the battery voltage Vbat outputted by the battery 114 to a first voltage (e.g., the voltage Vm) received by the dc-dc converter 810. The de-dc converter 810 is configured to regulate and provide the output voltage V2, in response to the first voltage (e.g., the voltage Vm) from the dc-dc converter 820. Accordingly, in response to the charging mode of FIG. 8B being selected, the controller may control a target power converter (e.g., dc-dc converter 820) to receive an input power from a first end and provide an output power through a second end.

For example, FIG. 8C illustrates another example charging mode and the power flow during a charging phase of the battery 114 in the charging circuit 800 of FIG. 8A, in accordance with some embodiments of the present disclosure. As shown in FIG. 8C, in the charging phase of the battery 114, the dc-dc converter 810 is configured to provide the output voltage V2, in response to the regulated DC input voltage V1 from the programmable power supply circuit 130. The dc-dc converter 820 is configured to provide a charging voltage Vc to the battery 114, in response to the regulated DC input voltage V1 from the programmable power supply circuit 130. Accordingly, in response to the charging mode of FIG. 8C being selected, the controller may control the target power converter (e.g., dc-dc converter 820) to receive the input power from the second end and provide the output power through the first end.

For example, FIG. 8D illustrates another example charging mode and the power flow in the charging circuit 800 of FIG. 8A, in accordance with some embodiments of the present disclosure. For example, the charging mode of FIG. 8D may be the first charging mode (e.g., point 610 in FIG. 6). As shown in FIG. 8D, the voltage V1 can be lowered, and the dc-dc converter 810 is configured to provide the output voltage V2, in response to the regulated DC input voltage V1 from the programmable power supply circuit 130. The controller may further disable the target power converter (e.g., the de-de converter 820) to stop power from flowing through the target power converter, in response to the charging mode of FIG. 8D being selected.

For example, FIG. 8E illustrates another example charging mode and the power flow in the charging circuit 800 of FIG. 8A, in accordance with some embodiments of the present disclosure. For example, the charging mode of FIG. 8E may be the second charging mode (e.g., point 620 in FIG. 6). As shown in FIG. 8E, the voltage V1 can be increased, and the dc-dc converters 810 and 820 are both enabled to allow greater power flowing through the charging circuit 800 to provide the output voltage V2, in response to the regulated DC input voltage V1 from the programmable power supply circuit 130.

In some other embodiments, in step 360, the controller may selectively enable or disable one or more switch devices (e.g., switch device 840) to bypass a charger transistor (e.g., charger transistor 830), based on the selected target charging mode. For example, in one or more intermediate charging modes (e.g., points 630, 640 in FIG. 6), the switch device 840. In addition, in one or more intermediate charging modes, the controller may also selectively operate a target power converter (e.g., dc-dc converter 820) in a forward direction or a backward direction in response to the required output voltage V2 for the selected target charging mode. Examples are provided in the above embodiments of FIG. 8B and FIG. 8C, and thus details are omitted herein for the sake of brevity.

It is noted that, in various embodiments, different converter types can be applied to implement a high-efficient converter for the de-de converter 820. For example, the dc-dc converter 820 may be a magnetic-based unregulated converter, an LLC converter, a switched-capacitor (SC)-based converter, etc. In some embodiments, one of the dc-dc converter 810 and the dc-dc converter 820 can be an unregulated converter, and the other one of the dc-dc converter 810 and the dc-dc converter 820 can be a regulated converter. During the discharging phase of the battery 114, the output voltage V2 can be regulated by the regulated converter. During the charging phase of the battery 114, the output voltage V2 and the charging voltage Vc can be regulated by the regulated converter and the programmable power supply circuit 130 providing the regulated DC input voltage V1.

For example, if the dc-dc converter 810 is an unregulated converter, then during the discharging phase of the battery 114 shown in FIG. 8B, the output voltage V2 can be indirectly controlled and regulated by the dc-dc converter 820 providing a regulated voltage Vm. During the charging phase of the battery 114 shown in FIG. 8C, the output voltage V2 can be indirectly controlled and regulated by the programmable power supply circuit 130 providing the regulated DC input voltage V1, and the charging voltage Vc can be regulated by the dc-dc converter 820.

In another example, if the dc-dc converter 820 is an unregulated converter, then during the discharging phase of the battery 114 shown in FIG. 8B, the output voltage V2 can be controlled and regulated by the de-dc converter 810 outputting the output voltage V2. During the charging phase of the battery 114 shown in FIG. 8C, the charging voltage Vc can be indirectly controlled and regulated by the programmable power supply circuit 130 providing the regulated DC input voltage V1, and the output voltage V2 can be regulated by the dc-dc converter 810. The embodiments of FIGS. 8A-8D can achieve a flash charging mechanism by using one regulating converter and one high-efficiency unregulated converter to provide the output voltage V2 at a high voltage (HV) level and provide the charging voltage Vc at a desired level for the battery 114. By running the dc-dc converter 810 and the dc-dc converter 820 simultaneously, the overall power efficiency can be improved. In some embodiments, different charging/discharging modes can be achieved by selecting the dc-dc converter(s) 810 or 820 to be enabled or disabled.

In addition to the architecture shown in FIG. 8A-FIG. 8E, the controller may also adjust the operation parameters for other architectures in response to the selected target charging mode. In the following paragraphs, other possible architectures of the charging circuit in the charging device will be discussed in accompany with FIG. 9 to FIG. 15, but the present disclosure is not limited thereto.

FIG. 9 is a block diagram of another example charging circuit 900, in accordance with some embodiments of the present disclosure. In the architecture shown in FIG. 9, the charging circuit 900 includes dc-dc converters 810 and 910. In some embodiments, the dc-dc converter 910 can be viewed as a bidirectional buck converter to provide the system voltage (e.g., output voltage V2). In some other embodiments, the dc-dc converter 910 can be viewed as a bidirectional boost converter for the battery 114 to be charged or discharged via the output node 990. The battery 114 is electrically coupled to the dc-dc converter 910. The dc-dc converter 910 is electrically coupled between the battery 114 and an output node 990 providing the output voltage V2. In some embodiments, the dc-dc converter 910 may be a boost converter or a charge pump converter providing a fixed offset between the battery voltage of the battery 114 and the output voltage V2. Similar to the embodiments above, the dc-dc converter 810 is electrically coupled to the programmable power supply circuit 130 and configured to convert the regulated DC input voltage V1 to the output voltage V2 at the output node 990. The battery 114 is configured to be charged or discharged, directly or indirectly via the output node 990.

Accordingly, the charging circuit 900 provides a charging mechanism, in which a single dc-dc converter 810 is configured to convert the regulated DC input voltage V1 to the output voltage V2, and the output voltage V2 can be used to charge the battery 114 and to provide the system voltage required by the circuits or devices in a next power stage connecting to the output node 990. When the programmable power supply circuit 130 is the power source, the charging circuit 900 receives the regulated DC input voltage V1 from the programmable power supply circuit 130 as the input voltage, with a proper voltage level controlled and regulated by the programmable power supply circuit 130. When the battery 114 is the power source, the dc-dc converter 910 may be configured to provide the output voltage V2 accordingly. Thus, the voltage range of the output voltage V2 can be narrower and within a desired voltage range. For example, in some embodiments, the output voltage V2 may be in the range of about 9V-5V for a 2S cell (i.e., 2 battery cells connected in series) application in a Narrow Voltage DC (NVDC) Architecture. In addition, the architecture shown in FIG. 9 also provides more flexibility for the regulation of the input voltage of the de-de converter 810 to maximize the power efficiency. Because the output voltage V2 may be indirectly controlled and regulated according to the regulated DC input voltage V1, the dc-dc converter 810 may be an unregulated converter with high efficiency. Accordingly, the switching loss can be reduced, and the overall efficiency can be improved.

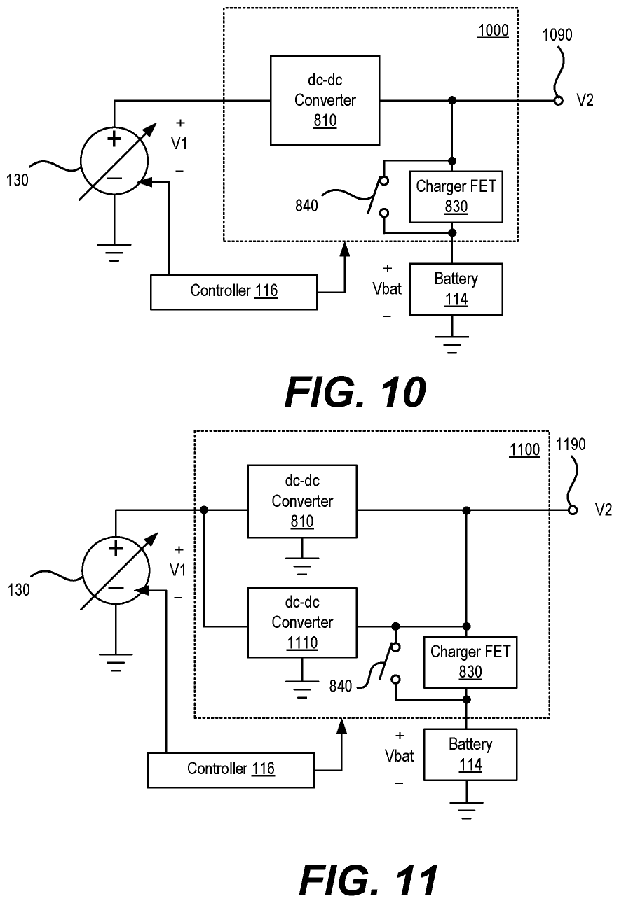

FIG. 10 is a block diagram of another example charging circuit 1000, in accordance with some embodiments of the present disclosure. Compared to the charging circuit 900 of FIG. 9, the charging circuit 1000 further includes a charger transistor 830 and a switch device 840 electrically coupled in parallel to the charger transistor 830. As shown in FIG. 10, the charger transistor 830 is electrically coupled in series between the dc-dc converter 810 and the battery 114 via the output node 1090. The charger transistor 830 is configured to enable or disable charging or discharging of the battery 114. For example, when the battery 114 is fully charged, the charger transistor 830 can be controlled in response to a corresponding control command from the controller 116 to disable the charging of the battery 114 by disconnecting the battery 114 from the dc-dc converter 810. On the other hand, when the battery 114 needs to be charged, the charger transistor 830 can be controlled in response to a corresponding control command from the controller 116 to enable the charging of the battery 114 based on the output voltage V2 outputted from the dc-dc converter 810.

Similarly, when the charging circuit 1000 receives the regulated DC input voltage V1 and performs the power conversion to provide the output voltage V2 based on the regulated DC input voltage V1, the charger transistor 830 can be controlled in response to a corresponding control command from the controller 116 to disable the discharging of the battery 114 by disconnecting the battery 114 from the output node 1090. On the other hand, when the battery needs to output the output voltage V2 for the next stage, the charger transistor 830 can be controlled in response to a corresponding control command from the controller 116 to discharge the battery 114 at the desired power level. Accordingly, a charging mechanism can be achieved by using an adjustable voltage source (e.g., the regulated DC input voltage V1 from the programmable power supply circuit 130) to replace a fixed voltage source to provide the output voltage V2 and provide power to charge the battery 114.

In some embodiments, the switch device 840 is an optional switching element. The switch device 840 in parallel to the charger transistor 830 is configured to bypass the charger transistor 830 when the switch device 840 is closed. Specifically, the switch device 840 can be controlled and used to bypass the charger transistor 830 in response to the selected charging mode when applicable and provide a less resistive power path between the battery 114 and the output node 1090. Accordingly, the overall power efficiency can be improved. For example, when the programmable power supply circuit 130 is used at the power source, the charging circuit 1000 may receive the regulated DC input voltage V1 to provide a high-efficiency output voltage V2. During a Constant Current (CC) mode, the switch device 840 may be enabled to bypass the charger transistor 830. In addition, when the battery 114 is used at the power source, the switch device 840 may also be enabled to bypass the charger transistor 830, so that the battery 114 can provide the output voltage V2 directly to the output node 1090. The circuit shown in FIG. 10 is an example and not meant to limit the present disclosure. For example, similar to the embodiments of FIG. 9, the charging circuit 1000 may further include another boost converter or charge pump converter providing a fixed offset between the battery voltage Vbat of the battery 114 and the output voltage V2 to ensure that the output voltage V2 does not reach or exceed the battery voltage Vbat. In some embodiments, the charging path including the charger transistor 830 can thus be removed accordingly.

FIG. 11 is a block diagram of another example charging circuit 1100, in accordance with some embodiments of the present disclosure. Compared to the charging circuit 800 of FIG. 8A-FIG. 8E, the charging circuit 1100 also includes another dc-dc converter 1110, and the dc-dc converter 810 and the dc-dc converter 1110 are electrically coupled in parallel.

In some embodiments, the dc-dc converter 810 and the dc-dc converter 1110 operate at the same conversion ratio. In some embodiments, one of the dc-dc converter 1110 and the dc-dc converter 810 may be unregulated. By arranging the dc-dc converter 1110 and the dc-dc converter 810 in parallel, the power path providing the output voltage V2 at the output node 1190 or the charging voltage to the battery 114 can be optimized with the dc-dc converter 1110 and the dc-dc converter 810 operating together to provide additional power.

Similar to the charging circuit 800, in some embodiments, the switch device 840 is electrically coupled in parallel to the charger transistor 830. In a charging phase of the battery 114, the switch device 840 is closed to bypass the charger transistor 830 to achieve high-efficiency charging to the battery 114. In a discharging phase of the battery 114, the switch device 840 is closed to bypass the charger transistor 830 to provide the output voltage V2 from the battery 114. Thus, when the power is drawn from the battery 114, the output voltage V2 may be the battery voltage Vbat, instead of a reduced voltage due to the voltage drop across the charger transistor 830.

The charging circuits shown in FIGS. 8A-8E and FIG. 11 are examples and not meant to limit the present disclosure. For example, similar to the above embodiments, the charging circuit 800 or 1100 may further include another boost converter or charge pump converter providing a fixed offset between the battery voltage Vbat of the battery 114 and the output voltage V2 to ensure that the output voltage V2 does not reach or exceed the battery voltage Vbat, and is at a specific level (e.g., 5V). In some embodiments, the charging path including the charger transistor 830 can thus be removed accordingly.

In the above embodiments of FIGS. 8A-8E to FIG. 11, the programmable power supply circuit 130 can be used as an adjustable and dynamic input voltage source to replace the fixed input voltage source in the traditional design. The programmable power supply circuit 130 can be applied to maximize the power efficiency by regulating the input voltage of the dc-dc converter(s). In some embodiments, the battery 114 can be connected to a boost converter or a charge pump converter for outputting a regulated output voltage V2. Accordingly, the voltage range of the output voltage V2 can be narrower. In some embodiments, a fixed offset between the battery voltage Vbat of the battery 114 and the output voltage V2 can be ensured.

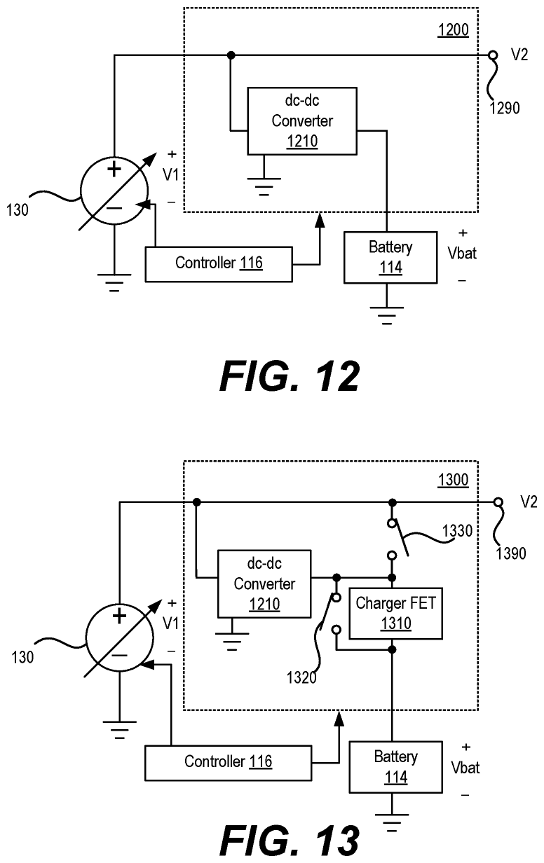

FIG. 12 is a block diagram of another example charging circuit 1200, in accordance with some embodiments of the present disclosure. Compared to the above embodiments, the charging circuit 1200 is designed for a Wide Voltage DC (WVDC) architecture. The charging circuit 1200 may be configured to provide the output voltage V2 with a wider voltage range compared to NVDC architectures in the above embodiments. In some embodiments, in the WVDC architecture, the output voltage V2 may be in the voltage range of about 20V-5V, which is broader than the voltage range of about 9V-5V for an example NVDC architecture, but the present disclosure is not limited thereto.

As shown in FIG. 12, the charging circuit 1200 includes a dc-dc converter 1210. The battery 114 is electrically coupled to the dc-dc converter 1210. Specifically, the charging circuit 1200 is electrically coupled to a programmable power supply circuit 130. Similar to the embodiments above, the programmable power supply circuit 130 can be an Adjustable Voltage Source (AVS). The programmable power supply circuit 130 is configured to provide the regulated DC voltage V1 as an output voltage V2 at an output node 1290 of the charging circuit 1200 to the next stage.

The dc-dc converter 1210 is electrically coupled to the programmable power supply circuit 130 at the output node 1290 and is configured to perform a voltage conversion between the output voltage V2 and a battery voltage Vbat of the battery 114. The battery 114 is electrically coupled to the dc-dc converter 1210 and configured to be charged or discharged, directly or indirectly, based on the battery voltage Vbat.

The charging circuit 1200 provides a charging mechanism without arranging a charger transistor in the charging circuit 1200. In some embodiments, the dc-dc converter 1210 may be a low-dropout regulator (LDO).

FIG. 13 is a block diagram of another example charging circuit 1300, in accordance with some embodiments of the present disclosure. The charging circuit 1300 may also be designed for the WVDC architecture. Compared to the charging circuit 1200 of FIG. 12, the charging circuit 1300 further includes a charger transistor 1310 and switch devices 1320 and 1330 electrically coupled to the charger transistor 1310.

As shown in FIG. 13, the charger transistor 1310 is electrically coupled in series between the dc-dc converter 1210 and the battery 114 and configured to enable or disable charging or discharging of the battery 114. The switch device 1320 is electrically coupled in parallel to the charger transistor 1310 and configured to bypass the charger transistor 1310 when the switch device 1320 is closed. The switch device 1330 is electrically coupled in parallel to the dc-dc converter 1210 and configured to enable a direct charging or discharging between the battery 114 and the output node 1390 of the charging circuit 1300 when the switch device 1330 is closed. In some embodiments, one or more of the charger transistor 1310 and switch devices 1320 and 1330 may be optional.

In particular, the charger transistor 1310 electrically coupled between the dc-dc converter 1210 and the battery 114 can minimize voltage and current ripples of the battery voltage Vbat across the battery 114. Similar to the embodiments above, the charger transistor 1310 and the switch device 1320 may be configured to enable or disable charging or discharging of the battery 114. Detailed operations of the charger transistor 1310 and the switch device 1320 are similar to those described above, and thus are not repeated herein for the sake of brevity.

In some embodiments, the switch device 1320 and the switch device 1330 can be used to achieve the direct charging of the battery 114. For example, when the battery 114 is charged using the output voltage V2 (or the regulated DC voltage V1 from the programmable power supply circuit 130) directly under a direct charging mode, the switch device 1320 and the switch device 1330 can be closed, in response to a corresponding control command from the controller 116, to provide a less resistive power path between the battery 114 and the output node 1390. Accordingly, the overall power efficiency can be improved.

On the other hand, when a voltage conversion between the output voltage V2 and the battery voltage Vbat of the battery 114 is needed, the switch device 1330 can be opened, and the battery 114 is charged by the voltage outputted by the dc-dc converter 1210. In other words, the charger transistor 1310, the switch device 1320, and the switch device 1330 can be respectively controlled to operate the charging circuit 1300 under various charging modes according to various system conditions and desired outcomes to supply the output voltage V2 to the load, and to charge or discharge the battery 114 efficiently without causing damages (e.g., over-charge or over-voltage) to the battery 114. In some embodiments, the charging circuit 1300 can dynamically switch between different charging modes by detecting the system conditions to optimize its operation automatically.

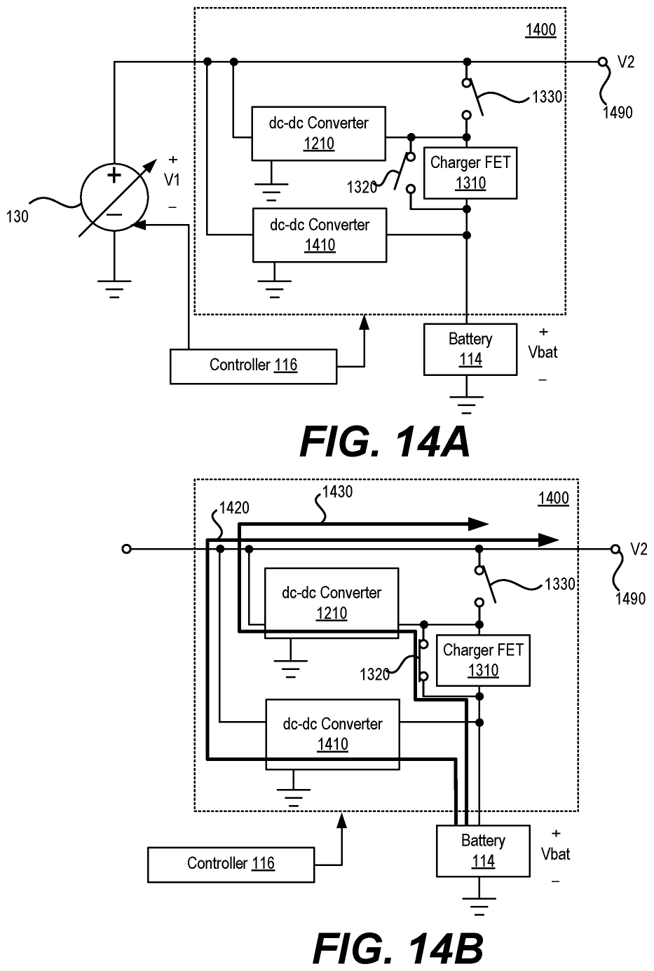

FIG. 14A is a block diagram of another example charging circuit 1400, in accordance with some embodiments of the present disclosure. Compared to the charging circuit 1300 of FIG. 13, the charging circuit 1400 further includes another dc-dc converter 1410. In some embodiments, one of the dc-dc converter 1210 and the dc-dc converter 1410 may be an unregulated converter, which may be a high-efficiency converter, and the other one of the dc-dc converter 1210 and the dc-dc converter 1410 may be a regulated converter. As shown in FIG. 14A, the dc-dc converter 1410 is electrically coupled in series between the programmable power supply circuit 130 and the battery 114. The charger transistor 1310 is electrically coupled between the dc-dc converter 1210 and the dc-dc converter 1410. In some embodiments, the dc-dc converter 1210 and the dc-dc converter 1410 are configured to operate simultaneously under certain power modes, but the present disclosure is not limited thereto.

FIG. 14B illustrates example power flows during a discharging phase of the battery 114 in the charging circuit 1400 of FIG. 14A, in accordance with some embodiments of the present disclosure. A power path 1420 in FIG. 14B indicates an example power flow during a discharging phase of the battery 114. In the power path 1420, during the discharging phase of the battery 114, the de-dc converter 1410 is configured to convert the battery voltage Vbat outputted by the battery 114 to the desired output voltage V2 at the output node 1490 of the charging circuit 1400. As shown in FIG. 14B, in some embodiments, the switch device 1320 can be closed, in response to a corresponding control command from the controller 116, to provide another power path 1430 during the discharging phase of the battery 114, in which the dc-dc converter 1210 is configured to convert the battery voltage Vbat outputted by the battery 114 to the desired output voltage V2. Accordingly, the charging circuit 1400 can supply greater output power in response to the system's request, with relative low power-rating dc-dc converters 1210 and 1410. When the required output power is relatively low, the charging circuit 1400 may also enable one of the dc-dc converters 1210 and 1410 to reduce the power loss and thus improve the overall power efficiency.

FIG. 14C illustrates example power flows during a charging phase of the battery 114 in the charging circuit 1400 of FIG. 14A, in accordance with some embodiments of the present disclosure. A power path 1440 in FIG. 14C indicates an example power flow during a charging phase of the battery 114. In the power path 1440, during the charging phase of the battery 114, the dc-dc converter 1410 is configured to convert the output voltage V2 (or the regulated DC voltage V1 from the programmable power supply circuit 130) to a desired charging voltage Vc to the battery 114, in the condition that the output voltage V2 is not within a desired voltage range for charging the battery 114. On the other hand, when the programmable power supply circuit 130 is able to provide the regulated DC voltage V1 at an optimized voltage level as the charging voltage Ve to charge the battery 114 directly, the switch devices 1320 and 1330 can be closed to provide a power path 1450 to enable to a direct charging to improve the efficiency.

It is appreciated that power paths 1420-1450 shown in FIG. 14B and FIG. 14C are merely examples and not meant to limit the present disclosure. In various embodiments, the charging circuit 1400 can control the de-de converters 1210 and 1410, the charger transistor 1310, and the switch devices 1320 and 1330 accordingly to operate at a desired charging or discharging mode to charge or discharge the battery 114 and output the output voltage V2 according to the system's needs using the programmable power supply circuit 130 or the battery 114 as the power source.

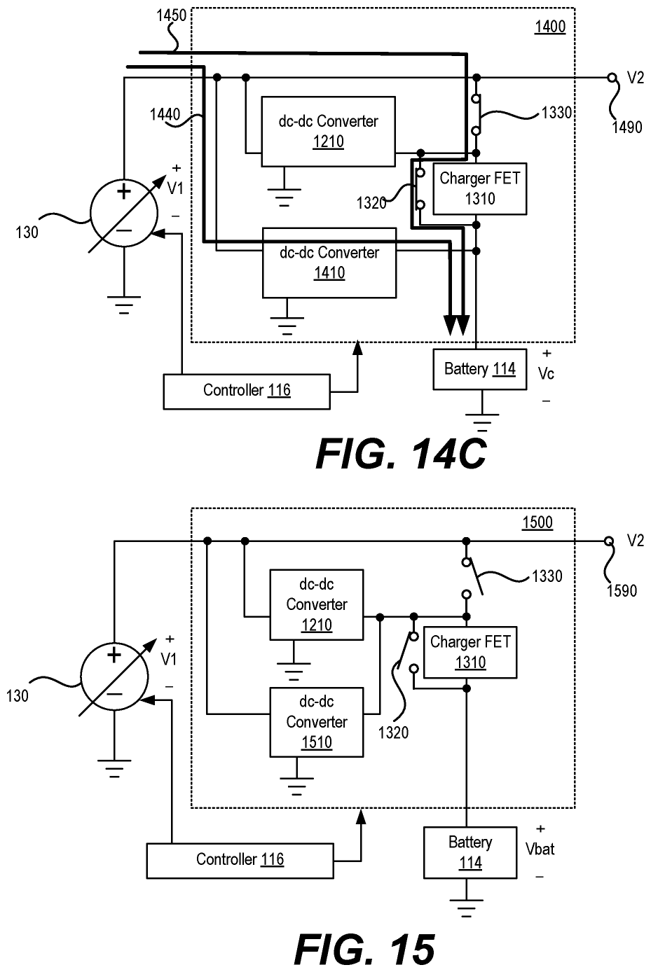

FIG. 15 is a block diagram of another example charging circuit 1500, in accordance with some embodiments of the present disclosure. Compared to the charging circuit 1300 of FIG. 13, the charging circuit 1500 further includes another dc-dc converter 1510. Similar to the embodiments of FIGS. 14A-14C, one of the dc-dc converter 1210 and the dc-dc converter 1510 may be an unregulated converter, and the other one of the dc-dc converter 1210 and the dc-dc converter 1510 may be a regulated converter.

As shown in FIG. 15, the dc-dc converters 1210 and 1510 are electrically coupled in parallel. In some embodiments, the dc-dc converter 1210 and the dc-dc converter 1510 operate at the same conversion ratio. By arranging the dc-dc converter 1210 and the dc-dc converter 1510 in parallel, the power path providing the output voltage V2 at the output node 1590 or the charging voltage to the battery 114 can be optimized with the dc-dc converter 1210 and the dc-dc converter 1510 operating together to provide additional power. Thus, similar to the charging circuit 1400 of FIGS. 14A-14C, the charging circuit 1500 can also supply greater output power in response to the system's request, with relatively low power-rating dc-dc converters 1210 and 1510 to achieve a flash charging. When the required output power is relatively low, the charging circuit 1500 may also enable one of the dc-dc converters 1210 and 1510 to reduce the power loss and thus improve the overall power efficiency.

Similar to the charging circuit 1400, in some embodiments, the switch device 1320 is electrically coupled in parallel to the charger transistor 1310. In the charging phase of the battery 114, the switch device 1320 can be closed to bypass the charger transistor 1310 to achieve high-efficiency charging to the battery 114. In the discharging phase of the battery 114, the switch device 1320 may be closed to bypass the charger transistor 1310 to provide the output voltage V2 from the battery 114 directly. Thus, when the power is drawn from the battery 114, the output voltage V2 may be the battery voltage Vbat, instead of a reduced voltage due to the voltage drop across the charger transistor 1310.

In some embodiments, one or both of the dc-dc converters 1210 and 1510 may be a boost converter or a charge pump converter to provide a fixed offset between the battery voltage Vbat of the battery 114 and the output voltage V2 to ensure that the output voltage V2 is at a specific level, when one or both of the switch devices 1320 and 1330 are opened and the power flows through one or both of the dc-dc converters 1210 and 1510. In some other embodiments, the charging circuit 1400 or 1500 may include additional components. The charging circuits shown herein are examples and not meant to limit the present disclosure.

In the above embodiments of FIG. 12 to FIG. 15, the programmable power supply circuit 130 can be used as an adjustable and dynamic input voltage source in various wide voltage DC architectures to replace the fixed input voltage source in the traditional design. The programmable power supply circuit 130 can be applied to maximize the power efficiency by regulating the input voltage of the dc-dc converter(s) (e.g., dc-dc converters 1210, 1410, and 1510) in the power converters. In some embodiments, the battery 114 can be connected to a boost converter or a charge pump converter for outputting a regulated output voltage V2. Accordingly, the voltage range of the output voltage V2 can be narrower. In some embodiments, a fixed offset between the battery voltage Vbat of the battery 114 and the output voltage V2 can be ensured.

In summary, various charging circuit architectures are provided to realize a highly efficient power supply system, offer improved charging mode candidates, and increase design flexibility compared to the existing solutions. The proposed charging devices or modules can be configured to charge an internal battery within the charging devices or modules and provide the output voltage for charging an electronic device. The user or the controller can leverage the flexibility provided by proposed charging architectures and control methods, so that the charging devices or modules can dynamically switch between different charging modes automatically or in response to manual commands, to adjust the charging efficiency, the charging power, or the required charging time to meet different charging requirements in various applications, and achieve multi-mode battery charging in response to various scenarios and system conditions.

In some embodiments, the proposed charging devices or modules may dynamically switch between different charging/discharging modes in response to various conditions and desired outcomes in real-time. The mode selection may be based on commands from a user to provide a personalized power management strategy for the user, and may also be based on commands from a controller to achieve an optimized power management. Examples of the charging/discharging modes may include a high-power charging mode which requires less charging time to complete the charging process, a high-efficiency charging mode which causes less damages to the battery and extends the battery life and the performance of the battery, various intermediate charging modes balancing the trade-off between the charging time and the efficiency, etc.

In the foregoing specification, embodiments have been described with reference to numerous specific details that can vary from implementation to implementation. Certain adaptations and modifications of the described embodiments can be made. It is also intended that the sequence of steps shown in figures is only for illustrative purposes and is not intended to be limited to any particular sequence of steps. As such, those skilled in the art can appreciate that these steps may be performed in a different order while implementing the same method.

The various example embodiments herein may be described in the general context of method steps or processes, which may be implemented in one aspect by a computer program product, embodied in a transitory or a non-transitory computer-readable medium. For example, a non-transitory computer-readable storage medium may store a set of instructions that are executable by one or more processors of a device to cause the device to perform a method for designing a frame structure for stacking circuit assemblies. A computer-readable medium may include removable and nonremovable storage devices including, but not limited to, Read Only Memory (ROM), Random Access Memory (RAM), compact discs (CDs), digital versatile discs (DVD), etc.

It is appreciated that certain features of the specification, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not to be considered essential features of those embodiments unless the embodiment is inoperative without those elements.

The embodiments may further be described using the following clauses:
1: A method for controlling a charging circuit, comprising: receiving battery information of a battery from an electrical device to be charged; receiving one or more characteristic parameters from the electrical device; selecting, from a plurality of charging mode candidates, a target charging mode according to the battery information and the one or more characteristic parameters; and controlling a controller to adjust one or more operating parameters of the charging circuit based on the selected target charging mode for charging the electrical device.
2: The method as paragraph 1 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
3: The method as either of paragraphs 1 or 2 describe, wherein the device temperature information comprises one or more of an average device temperature, a maximum device temperature, or a device skin temperature.
4: The method as any of paragraphs 1-3 describe, wherein the battery information comprises a battery state of charge, a battery state of health, a temperature of the battery, or a combination thereof.
5: The method as any of paragraphs 1-4 describe, wherein controlling the controller to adjust the one or more operation parameters of the charging circuit based on the selected target charging mode comprises: adjusting a charging efficiency or a charging power or time to reach a percentage of full charge of a battery.
6: The method as any of paragraphs 1-5 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
7: The method as any of paragraphs 1-6 describe, wherein controlling the controller to adjust the one or more operation parameters of the charging circuit based on the selected target charging mode comprises: selectively enabling or disabling one or more power converters in the charging circuit based on the selected target charging mode.
8: The method as any of paragraphs 1-7 describe, wherein controlling the controller to adjust the one or more operation parameters of the charging circuit based on the selected target charging mode comprises: selectively controlling a voltage level of a supply voltage outputted by an adjustable voltage source in the charging circuit, based on the selected target charging mode.
9: The method as any of paragraphs 1-8 describe, wherein controlling the controller to adjust the one or more operation parameters of the charging circuit based on the selected target charging mode comprises: selectively controlling a power flow direction of one or more power converters in the charging circuit, based on the selected target charging mode.
10: The method as any of paragraphs 1-9 describe, wherein selectively controlling the power flow direction of the one or more power converters in the charging circuit further comprises: in response to a first charging mode being selected, controlling a target power converter to receive an input power from a first end and provide an output power through a second end; in response to a second charging mode being selected, controlling the target power converter to receive the input power from the second end and provide the output power through the first end.
11: The method as any of paragraphs 1-10 describe, wherein selectively controlling the power flow direction of the one or more power converters in the charging circuit further comprises: in response to a third charging mode being selected, disabling the target power converter to stop power from flowing through the target power converter.
12: The method as any of paragraphs 1-11 describe, wherein controlling the controller to operate the charging circuit based on the selected target charging mode comprises: selectively enabling or disabling one or more switch devices to bypass a charger transistor in the charging circuit, based on the selected target charging mode.
13: The method as any of paragraphs 1-12 describe, further comprising: in response to a detection of a mode selection command from a user, selecting, from the plurality of charging mode candidates, the target charging mode according to the mode selection command.
14: The method as any of paragraphs 1-13 describe, further comprising: determining a plurality of operating parameters for operating the charging circuit according to the selected target charging mode and an architecture of the charging circuit.
15: The method as any of paragraphs 1-14 describe, further comprising: retrieving, according to the target charging mode and the architecture of the charging circuit, a corresponding target set of the operating parameters selected from a plurality of candidate sets of the operating parameters stored in a memory.
16: The method as any of paragraphs 1-15 describe, further comprising: obtaining each candidate set by a processor, each candidate set being associated with the architecture of the charging circuit and one of the charging mode candidates.
17: The method as any of paragraphs 1-16 describe, wherein obtaining each candidate set by the processor comprises: applying a neural network to process a plurality of input parameters to obtain each candidate set.
18: The method as any of paragraphs 1-17 describe, wherein the input parameters for the neural network comprise the target charging mode, the architecture of the charging circuit, ambient temperature, and the battery information.
19: The method as any of paragraphs 1-18 describe, wherein the neural network is configured to perform a regression between a set of the operating parameters and a corresponding charging efficiency or a corresponding charging power or time to reach a percentage of full charge of a battery.
20: The method as any of paragraphs 1-19 describe, wherein the neural network is a perceptron network, a classifier network, an optimization network, or any combination thereof.
21: The method as any of paragraphs 1-20 describe, further comprising: changing the target charging mode during a charging cycle of the battery.
22: A controller for controlling a charging circuit, comprising: a memory storing a set of instructions; one or more processors coupled to the memory and configured to execute the set of instructions to cause the controller to perform operations comprising: selecting, from a plurality of charging mode candidates, a target charging mode according to battery information of a battery and one or more characteristic parameters received from an electrical device to be charged; and adjusting one or more operating parameters of the charging circuit based on the selected target charging mode for charging the electrical device.
23: The controller as paragraph 22 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
24: The controller as either of paragraphs 22 or 23 describe, wherein the device temperature information comprises one or more of an average device temperature, a maximum device temperature, or a device skin temperature.
25: The controller as any of paragraphs 22-24 describe, wherein the battery information comprises a battery state of charge, a battery state of health, a temperature of the battery, or a combination thereof.
26: The controller as any of paragraphs 22-25 describe, wherein the operations further comprise: adjusting the one or more operation parameters of the charging circuit based on the selected target charging mode to adjust a charging efficiency or a charging power or time to reach a percentage of full charge of a battery.
27: The controller as any of paragraphs 22-26 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
28: The controller as any of paragraphs 22-27 describe, wherein the operations further comprise: selectively enabling or disabling one or more power converters in the charging circuit based on the selected target charging mode.
29: The controller as any of paragraphs 22-28 describe, wherein the operations further comprise: selectively controlling a voltage level of a supply voltage outputted by an adjustable voltage source in the charging circuit, based on the selected target charging mode.
30: The controller as any of paragraphs 22-29 describe, wherein the operations further comprise: selectively controlling a power flow direction of one or more power converters in the charging circuit, based on the selected target charging mode.
31: The controller as any of paragraphs 22-30 describe, wherein the controller is configured to control a target power converter to receive an input power from a first end and provide an output power through a second end in response to a first charging mode being selected, and control the target power converter to receive the input power from the second end and provide the output power through the first end in response to a second charging mode being selected.
32: The controller as any of paragraphs 22-31 describe, wherein the controller is configured to disable the target power converter to stop power from flowing through the target power converter in response to a third charging mode being selected.
33: The controller as any of paragraphs 22-32 describe, wherein the operations further comprise: selectively enabling or disabling one or more switch devices to bypass a charger transistor in the charging circuit, based on the selected target charging mode.
34: The controller as any of paragraphs 22-33 describe, wherein the operations further comprise: in response to a detection of a mode selection command from a user, selecting, from the plurality of charging mode candidates, the target charging mode according to the mode selection command.
35: The controller as any of paragraphs 22-34 describe, wherein the operations further comprise: determining a plurality of operating parameters for operating the charging circuit according to the selected target charging mode and an architecture of the charging circuit.
36: The controller as any of paragraphs 22-35 describe, wherein the operations further comprise: retrieving, according to the target charging mode and the architecture of the charging circuit, a corresponding target set of the operating parameters selected from a plurality of candidate sets of the operating parameters stored in a memory.
37: The controller as any of paragraphs 22-36 describe, wherein each candidate set is associated with one of the charging mode candidates and the architecture of the charging circuit and obtained by a processor.
38: The controller as any of paragraphs 22-37 describe, wherein each candidate set is obtained by the processor by applying a neural network to process a plurality of input parameters.
39: The controller as any of paragraphs 22-38 describe, wherein the input parameters for the neural network comprise the target charging mode, the architecture of the charging circuit, ambient temperature, and the battery information.
40: The controller as any of paragraphs 22-39 describe, wherein the neural network is configured to perform a regression between a set of the operating parameters and a corresponding charging efficiency or a corresponding charging power or time to reach a percentage of full charge of a battery.
41: The controller as any of paragraphs 22-40 describe, wherein the neural network is a perceptron network, a classifier network, an optimization network, or any combination thereof.
42: The controller as any of paragraphs 22-41 describe, wherein the operations further comprise: changing the target charging mode during a charging cycle of the battery.
43: A charging device, comprising: a charging circuit electrically coupled to a programmable power supply circuit, the programmable power supply circuit being configured to provide a regulated DC input voltage, the charging circuit comprising: a first dc-dc converter electrically coupled to the programmable power supply circuit and configured to convert the regulated DC input voltage to an output voltage at an output node; and a controller configured to: receive battery information from an electrical device to be charged; receive one or more characteristic parameters; select, from a plurality of charging mode candidates, a target charging mode according to the battery information and the one or more characteristic parameters; and adjust one or more operating parameters of the charging circuit based on the selected target charging mode for charging an electrical device.
44: The charging device as paragraph 43 describes, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.
45: The charging device as either of paragraphs 43 or 44 describe, wherein the device temperature information comprises one or more of an average device temperature, a maximum device temperature, or a device skin temperature.
46: The charging device as any of paragraphs 43-45 describe, wherein the battery information comprises a battery state of charge, a battery state of health, a temperature of the battery, or a combination thereof.
47: The charging device as any of paragraphs 43-46 describe, wherein the controller is configured to adjust the one or more operation parameters of the charging circuit based on the selected target charging mode to: adjust a charging efficiency or a charging power or time to reach a percentage of full charge of a battery.
48: The charging device as any of paragraphs 43-47 describe, wherein the one or more operation parameters are associated with one or more of a voltage level of a supply voltage outputted by an adjustable voltage source in the charging circuit, an architecture of the charging circuit, or a power flow direction of one or more power converters in the charging circuit.
49: The charging device as any of paragraphs 43-48 describe, further comprising: a battery electrically coupled to the first dc-dc converter, and configured to be charged or discharged, directly or indirectly via the output node; wherein the charging circuit further comprises a second dc-dc converter electrically coupled in series between the programmable power supply circuit and the battery, one of the first dc-dc converter and the second dc-dc converter being an unregulated converter; and wherein the controller is further configured to selectively enable or disable the first dc-dc converter or the second dc-dc converter based on the selected target charging mode.
50: The charging device as any of paragraphs 43-49 describe, wherein the controller is further configured to selectively control a voltage level of the regulated DC input voltage, based on the selected target charging mode.
51: The charging device as any of paragraphs 43-50 describe, further comprising: a battery electrically coupled to the first de-de converter, and configured to be charged or discharged, directly or indirectly via the output node; wherein the charging circuit further comprises a second de-de converter electrically coupled in series between the programmable power supply circuit and the battery, one of the first de-de converter and the second dc-dc converter being an unregulated converter; and wherein the controller is further configured to selectively control a power flow direction of the first dc-dc converter and the second de-de converter, based on the selected target charging mode.
52: The charging device as any of paragraphs 43-51 describe, wherein the controller is configured to control the second de-de converter to receive an input power from a first end and provide an output power through a second end in response to a first charging mode being selected, and control the second de-de converter to receive the input power from the second end and provide the output power through the first end in response to a second charging mode being selected.
53: The charging device as any of paragraphs 43-52 describe, wherein the controller is configured to disable the second dc-dc converter to stop power from flowing through the second dc-dc converter in response to a third charging mode being selected.
54: The charging device as any of paragraphs 43-53 describe, wherein the charging circuit further comprises: a battery electrically coupled to the first dc-dc converter, and configured to be charged or discharged, directly or indirectly via the output node; a charger transistor electrically coupled in series between the first dc-dc converter and the battery via the output node and configured to enable or disable charging or discharging of the battery; and a switch device electrically coupled in parallel to the charger transistor and configured to bypass the charger transistor when the switch device is closed; wherein the controller is further configured to selectively enable or disable the switch device to bypass the charger transistor, based on the selected target charging mode.
55: The charging device as any of paragraphs 43-54 describe, wherein in response to a detection of a mode selection command from a user, the controller is further configured to select, from the plurality of charging mode candidates, the target charging mode according to the mode selection command.
56: The charging device as any of paragraphs 43-55 describe, wherein the controller is further configured to determine a plurality of operating parameters for operating the charging circuit according to the selected target charging mode and an architecture of the charging circuit.
57: The charging device as any of paragraphs 43-56 describe, wherein the controller is further configured to retrieve, according to the target charging mode and the architecture of the charging circuit, a target set of the operating parameters selected from a plurality of candidate sets of the operating parameters stored in a memory.
58: The charging device as any of paragraphs 43-57 describe, wherein each candidate set is obtained by a processor and associated with one of the charging mode candidates and the architecture of the charging circuit.
59: The charging device as any of paragraphs 43-58 describe, wherein the processor is configured to apply a neural network to process a plurality of input parameters to obtain each candidate set.
60: The charging device as any of paragraphs 43-59 describe, wherein the input parameters for the neural network comprise the target charging mode, the architecture of the charging circuit, ambient temperature, and the battery information.
61: The charging device as any of paragraphs 43-60 describe, wherein the neural network is configured to perform a regression between a set of the operating parameters and a corresponding charging efficiency or a corresponding charging power or time to reach a percentage of full charge of a battery.
62: The charging device as any of paragraphs 43-61 describe, wherein the neural network is a perceptron network, a classifier network, an optimization network, or any combination thereof.
63: The charging device as any of paragraphs 43-62 describe, wherein the controller is further configured to change the target charging mode during a charging cycle of the battery.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The invention claimed is:

1. A method for controlling a charging circuit, comprising:
receiving battery information of a battery from an electrical device to be charged;
receiving one or more characteristic parameters from the electrical device;
selecting, from a plurality of charging mode candidates, a target charging mode according to the battery information and the one or more characteristic parameters; and
controlling a controller to adjust one or more operating parameters of the charging circuit based on the selected target charging mode for charging the electrical device.

2. The method of claim 1, wherein the one or more characteristic parameters comprise data associated with the electrical device, including a device type, a use pattern of a user of the electrical device, location information, position information, time information, movement information, device temperature information, ambient temperature information, real-time power consumption information, real-time carbon emission information, historical power consumption information, or any combination thereof.

3. The method of claim 2, wherein the device temperature information comprises one or more of an average device temperature, a maximum device temperature, or a device skin temperature.

4. The method of claim 1, wherein the battery information comprises a battery state of charge, a battery state of health, a temperature of the battery, or a combination thereof.

5. The method of claim 1, wherein controlling the controller to adjust the one or more operation parameters of the charging circuit based on the selected target charging mode comprises:
adjusting a charging efficiency or a charging power or time to reach a percentage of full charge of a battery.

6. The method of claim 1, wherein the one or more operation parameters are associated with one or more of a voltage level of a supply voltage outputted by an adjustable voltage source in the charging circuit, an architecture of the charging circuit, or a power flow direction of one or more power converters in the charging circuit.

7. The method of claim 1, wherein controlling the controller to adjust the one or more operation parameters of the charging circuit based on the selected target charging mode comprises:
selectively enabling or disabling one or more power converters in the charging circuit based on the selected target charging mode.

8. The method of claim 1, wherein controlling the controller to adjust the one or more operation parameters of the charging circuit based on the selected target charging mode comprises:
selectively controlling a voltage level of a supply voltage outputted by an adjustable voltage source in the charging circuit, based on the selected target charging mode.

9. The method of claim 1, wherein controlling the controller to adjust the one or more operation parameters of the charging circuit based on the selected target charging mode comprises:
selectively controlling a power flow direction of one or more power converters in the charging circuit, based on the selected target charging mode.

10. The method of claim 9, wherein selectively controlling the power flow direction of the one or more power converters in the charging circuit further comprises:
in response to a first charging mode being selected, controlling a target power converter to receive an input power from a first end and provide an output power through a second end;
in response to a second charging mode being selected, controlling the target power converter to receive the input power from the second end and provide the output power through the first end.

11. The method of claim 10, wherein selectively controlling the power flow direction of the one or more power converters in the charging circuit further comprises:
in response to a third charging mode being selected, disabling the target power converter to stop power from flowing through the target power converter.

12. The method of claim 1, wherein controlling the controller to operate the charging circuit based on the selected target charging mode comprises:
selectively enabling or disabling one or more switch devices to bypass a charger transistor in the charging circuit, based on the selected target charging mode.

13. The method of claim 1, further comprising:
in response to a detection of a mode selection command from a user, selecting, from the plurality of charging mode candidates, the target charging mode according to the mode selection command.

14. The method of claim 1, further comprising:
determining a plurality of operating parameters for operating the charging circuit according to the selected target charging mode and an architecture of the charging circuit.

15. The method of claim 14, further comprising:
retrieving, according to the target charging mode and the architecture of the charging circuit, a corresponding target set of the operating parameters selected from a plurality of candidate sets of the operating parameters stored in a memory.

16. The method of claim 15, further comprising:
obtaining each candidate set by a processor, each candidate set being associated with the architecture of the charging circuit and one of the charging mode candidates.

17. The method of claim 16, wherein obtaining each candidate set by the processor comprises:
applying a neural network to process a plurality of input parameters to obtain each candidate set.

18. The method of claim 17, wherein the input parameters for the neural network comprise the target charging mode, the architecture of the charging circuit, ambient temperature, and the battery information.

19. The method of claim 17, wherein the neural network is configured to perform a regression between a set of the operating parameters and a corresponding charging efficiency or a corresponding charging power or time to reach a percentage of full charge of a battery.

20. The method of claim 17, wherein the neural network is a perceptron network, a classifier network, an optimization network, or any combination thereof.

21. The method of claim 1, further comprising:
changing the target charging mode during a charging cycle of the battery.

22.-63. (canceled)
